(19) United States
(12) Patent Application Publication
(10) Pub. No.: US 2006/0212595 A1
(43) Pub. Date: Sep. 21, 2006

(54) Method and computer-readable medium for associating sequence numbers with data blocks for distribution of data in a peer-to-peer network

(75) Inventors: Xiangyang Chen, Beijing (CN); Mingjian Yu, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development (Beijing) Co., Ltd., Beijing (CN)

(21) Appl. No.: 11/232,155

(22) Filed: Sep. 21, 2005

Related U.S. Application Data
(60) Provisional application No. 60/662,131, filed on Mar. 15, 2005.

(51) Int. Cl. G06F 15/16

(52) U.S. Cl. 709/232

(57) ABSTRACT

A method and computer-readable medium for identifying multimedia content in a peer-to-peer network is provided. A multimedia data structure is segmented into a plurality of data blocks. Each of a plurality of sequence numbers is respectively associated with one of the plurality of data blocks. The plurality of data blocks are stored, and the plurality of sequence numbers are recorded. At least a portion of the plurality of data blocks are distributed in the peer-to-peer network in association with respective sequence numbers.

### RELATED APPLICATION DATA

This patent application claims the benefit of provisional U.S. Patent Application Ser. No. 60/662,131, filed Mar. 15, 2005.

### BACKGROUND

In a client-server network adapted to provide streaming multimedia data such as video or audio, many clients may participate in a video streaming session. The processing capacity of a media server in such a network is limited. If the number of clients connected to the media server exceeds the processing or transmission capacity of the server, the media server may be unable to provide a high quality of service to the clients, crash, discontinue service to clients, or refuse service or connection to clients.

Peer-to-peer networking solutions reduce or eliminate capacity deficiencies that are common in client/server network configurations. Peer-to-peer network technologies distribute processing and transmission demands among peer clients in the network. Thus, as a peer-to-peer network grows in size, so to does the processing and transmission capacity of the peer-to-peer network.

Client/server networks typically utilize sequence numbers to enable data receipt verification, proper ordering of received data, and the like. However, sequence numbers are not statically associated with content. For example, a file server may assign a sequence number to a particular data block of a file prior to transmitting the data block to a client. At another time, the file server may assign another sequence number to another instance of the same data block to be transmitted to another client. Thus, assignment of a sequence number by a file server provides an identification mechanism only for the transmitting and receiving entities and only for a single transmission/reception operation.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a client-server network that may provide multimedia services to various clients;

FIG. 2 is a diagrammatic representation of an embodiment of a peer-to-peer network that facilitates distribution of multimedia content;

FIG. 3 is a diagrammatic representation of an embodiment of a multimedia file having content that may be distributed in a peer-to-peer network;

FIG. 4 is a diagrammatic representation of an embodiment of segmented multimedia content formatted for transmission in a peer-to-peer network;

FIG. 5 is a diagrammatic representation of an embodiment of segmented content encapsulated in a peer-to-peer transport packet, or data block, that may be distributed within a peer-to-peer network;

FIG. 6 is a diagrammatic representation of an embodiment of a software configuration that facilitates distribution and storage of multimedia content in a peer-to-peer network;

FIGS. 7A-7C are respective diagrammatic representations of an embodiment of data block storage by clients of a peer-to-peer network;

FIG. 8 is a flowchart of an embodiment of a source server processing routine that facilitates distribution of content in a peer-to-peer network;

FIG. 9 is a flowchart of an embodiment of a client processing routine that facilitates distribution of content in a peer-to-peer network;

FIG. 10 is a flowchart of an embodiment of a processing routine that facilitates distribution of a sequence number scope to clients in a peer-to-peer network; and

FIG. 11 is a flowchart of an embodiment of a data block distribution processing routine that facilitates distribution of data blocks to clients in a peer-to-peer network

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

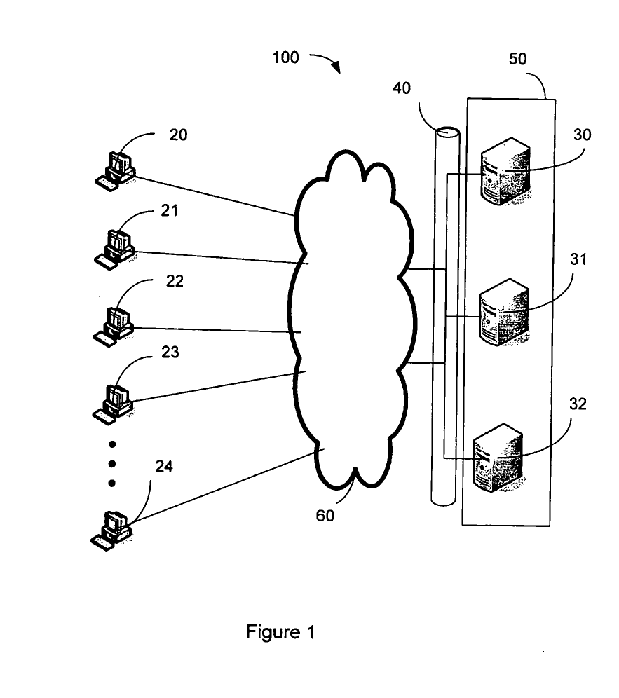

FIG. 1 is a diagrammatic representation of an embodiment of a client-server network 100 that may provide multimedia services to various clients 20-24. Client-server network 100 comprises multiple content servers 30-32 configured in a cluster 50. Content servers 30-32 may store or otherwise access common content, such as hypertext markup language (HTML) pages, streaming content, or other data structures. For example, content servers 30-32 may access and stream content in a RealAudio, RealVideo, advanced streaming format (ASF), or another streaming media format. Content servers 30-32 may be interconnected by a network link 40, such as an Ethernet. Services provided by cluster 50 may be load-balanced among content servers 30-32. Clients 20-24 are provided data content by connecting with cluster 50, for example by way of a public network 60, such as the Internet.

Each of content servers 30-32 may provide service processing for a finite number of clients, and thus the client service capacity of cluster 50 is limited to the aggregate service capacity of content servers 30-32. If the demand placed on cluster 50 becomes too large, the service quality provided to clients 20-24 may be degraded or one or more of clients 20-24 may be disconnected from cluster 50. Conventional solutions for addressing excessive loads placed on cluster 50 generally include expanding the processing capacity of cluster 50, for example by adding additional content servers to cluster 50, upgrading the capacity of existing content servers, or by other mechanisms. Such system reconfigurations are costly due to both hardware and labor expenses and do not address transmission capacity deficiencies of cluster 50.

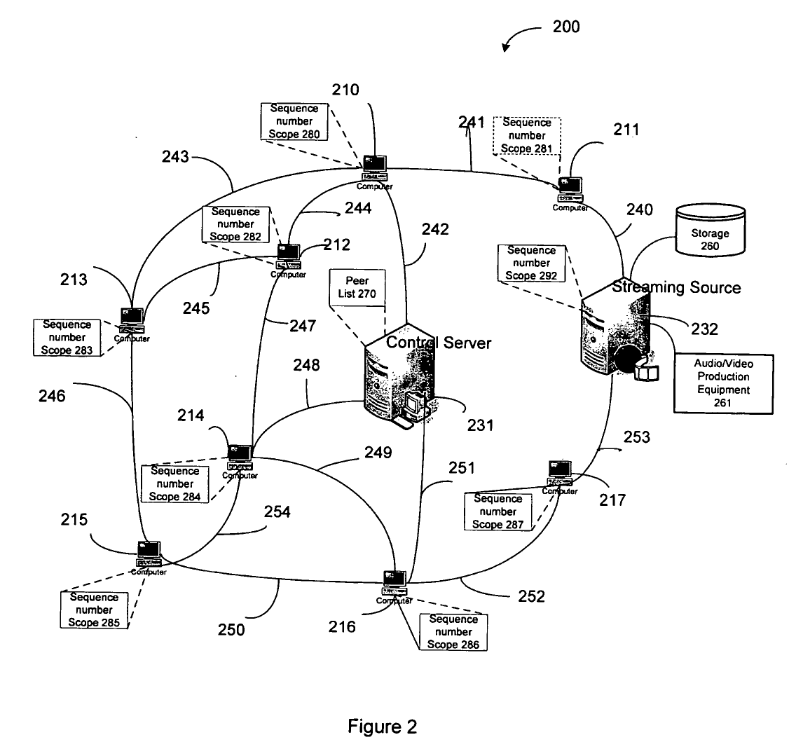

FIG. 2 is a diagrammatic representation of an embodiment of a peer-to-peer network 200 that facilitates distribution of content such as multimedia data. Network 200 includes various peer clients 210-217 that may be interconnected with other clients in network 200. Additionally, network 200 may include a control server 231. One or more clients may connect with control server 231 in addition to other network clients. Clients 210-217 may connect with other network clients and control server 231 by network connections 240-253, such as wire, wireless communication links, fiber optic cables, or other suitable network media. Additionally, clients 210-217 may connect with a source server 232 that is external to peer-to-peer network 200. In the illustrative example, clients 211 and 217 are connected with source server 232 via respective links 240 and 253.

Control server 231 may facilitate connection of new clients within network 200 and organize clients 210-217 that have joined network 200. Clients 210-217 may be implemented as data processing systems, such as personal computers, wired or wireless laptop computers, personal digital assistants, or other computational devices capable of network communications.

Source server 232 may be implemented as a server that stores or accesses multimedia content, such as video, audio, or the like, and transmits the data to one or more clients in network 200. For example, the multimedia content may be retrieved from a file that is accessed by source server 232 from a storage device 260. Alternatively, the multimedia content may be produced from, for example, audio/video production equipment 261 that is interfaced with source server 232. The multimedia content may comprise data encoded in a native streaming format, such as RealAudio formatted files, RealVideo formatted files, ASF, or another streaming format that may be processed by a streaming media application, such as RealPlayer, Windows Media Player, or another streaming media application. The native formatted streaming content may be encapsulated in a network transport format that facilitates transmission of data among peer clients of network 200. Source server 232 may segment multimedia content into data blocks that are distributed within network 200. Various clients 210-217 may receive and store different data blocks of the multimedia content. In accordance with embodiments described herein, universal serial numbers re associated with data blocks that are distributed in peer-to-peer network 200 such that each instance of a data block that includes identical multimedia content shares a common sequence number associate therewith. In this manner, identification of a data block that stores particular content can be made based on the sequence number of the data block.

Control server 231 may maintain or generate a peer list 270 that includes connectivity information, such as a network address and port number, of respective peer clients that are connected within peer-to-peer network 200. When control server 231 generates peer list 270, connectivity information of source server 232 may be the only connectivity information included in peer list 270. A client joins peer-to-peer network 200 by first connecting with control server 231 and submitting a request for peer list 270. The control server returns peer list 270 to the requesting client, and the client joins network 200 by selecting one or more nodes having connectivity information included in peer list 270 and connecting with the selected nodes.

When a new client joins peer-to-peer network 200, control server 232 may add connectivity information of the newly joining client to peer list 270. In this manner, as additional clients join peer-to-peer network 200, the availability of peer clients with which subsequently joining clients may connect is increased. Connectivity information of source server 232 may be removed from peer list 270, for example when the number of clients connected within peer-to-peer network 200 reaches a pre-defined threshold. In this manner, the session load placed on source server 232 may be reduced. A client connected within peer-to-peer network 200 that desires multimedia content originally provided by source server 232 may submit a query for the multimedia content to peer clients with which the requesting client is connected. For example, the query may specify a range of data block sequence numbers. If no peer clients within network 200 have the requested multimedia content (or no peer clients within network 200 are available for delivery of the multimedia content to the requesting client), the requesting client may obtain the multimedia content from source server 232.

In accordance with embodiments described herein, a peer client that has cached multimedia content maintains or generates a sequence number scope list that specifies the sequence numbers of data blocks maintained by the client. The client may then transmit the sequence number scope list to other peer clients when a peer client establishes a connection with the client. In the illustrative example of FIG. 2, each of peer clients 210-217 maintains a respective sequence number scope list 280-287 that identifies the sequence numbers of data blocks maintained by peer clients 210-217 that may be distributed to other peer clients within peer-to-peer network 200. Likewise, source server 232 maintains a sequence number scope list 292 that identifies the sequence numbers of data blocks maintained by source server 232 that may be distributed to clients within peer-to-peer network 200. In this manner, clients desiring to download multimedia content from one or more of peer clients 210-217 and/or source server 232 may specify particular data blocks of the multimedia data by including one or more sequence numbers of the multimedia data in a request for multimedia content. Because the sequence number are associated with multimedia content, sequence number associated with particular multimedia data-blocks provide a universal identifier of the content within peer-to-peer network and with a source server that may be external to peer-to-peer network 200.

Network 200 may comprise a transient Internet network, and thus clients 210-217 and control server 231 may use the Transmission Control Protocol/Internet Protocol (TCP/IP) suite of protocols to communicate with one another. Alternatively, network 200 may be implemented in any number of different types of networks, such as for example, an intranet, a local area network (LAN), or a wide area network (WAN). FIG. 2 is intended as an example, and not as an architectural limitation of embodiments described herein.

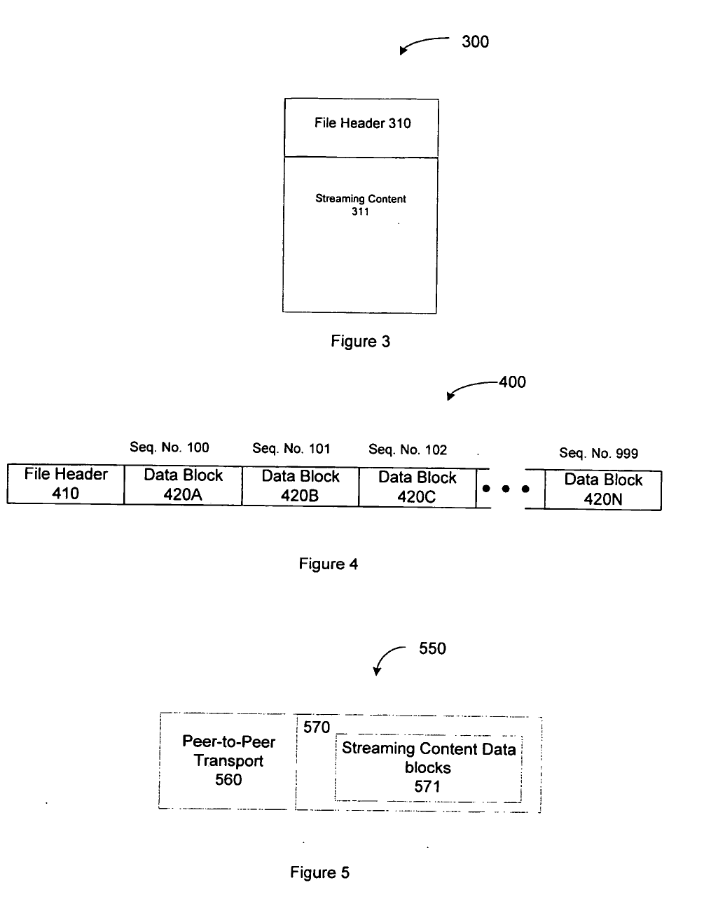

FIG. 3 is a diagrammatic representation of an embodiment of a multimedia file 300 having content that may be distributed in peer-to-peer network 200. Multimedia file 300 may include a file header 310 and multimedia content 311. File header 310 may include various control or information fields that facilitate processing of multimedia content 311 for proper playback or processing thereof. For example, file header 310 may include fields that have values specifying an encoder used for encoding content 311, protocol version of the content, the length of data included in file 300, or other data that may be used for processing of the content. Content 311 may include encoded video, audio, or other multimedia data.

File 300 may be provided to clients from source server 232 (FIG. 2). For example, source server 232 may fetch file 300 from storage device 260 connected or otherwise interfaced with source server 232, or multimedia file 300 may be generated by source server 232 and adjunct equipment, for example from audio/video production equipment 261. In this configuration, source server 232, or equipment connected therewith, generates file header 310 having parameters or field values that facilitate processing of content 311.

Multimedia content, whether retrieved from a file or produced by audio/video production equipment or another source, may be segmented into data blocks for transmission in peer-to-peer network 200. In accordance with embodiments described herein, multimedia content data blocks having multimedia content are associated with a sequence number to facilitate distribution of multimedia content within peer-to-peer network 200.

FIG. 4 is a diagrammatic representation of an embodiment of segmented multimedia content 400 formatted for transmission in a peer-to-peer network. Segmented multimedia content 400 may be generated by source server 232 by segmenting or otherwise dividing multimedia file 300 into segments or data blocks. For example, the source server may extract file header 310 from multimedia content file 300 and store the extracted information as a file header block 410 in a cache or other storage device. Additionally, source server 232 may partition or otherwise segment content 311 into groups of one or more data blocks 420A-420N. Groups of data blocks may then be transmitted to peers connected with source server 232, and source server 232 may store data blocks 420A-420N in a local storage device. Preferably, source server 232 associates a respective sequence number with each data block of the multimedia content. For example, source server 232 may associate one of a series of sequence numbers to each data block 420A-420N of segmented multimedia content 400. In the illustrative example, each of data blocks 420A-420N have a respective sequence number 100-999 associated therewith. Source server 232 may then generate or update a sequence number scope list, e.g., list 292 shown in FIG. 2, to indicate the sequence numbers of data blocks stored by source server 232.

One or more of data blocks 420A-420N may be received by a client and cached thereby for later transmission to other peer clients requesting the multimedia content. A client, upon receipt of one or more data blocks preferably generates or updates its sequence number scope list to accurately indicate the data blocks currently stored by the client. Peer clients may store different or common sets of data blocks 420A-420N. When a peer client connects with another peer client, the client with which the peer client has connected preferably transmits its sequence number scope list to the connecting client. Thus, a client may determine which data blocks are cached and available for download by examining the sequence numbers of data blocks stored by other clients.

FIG. 5 is a diagrammatic representation of an embodiment of segmented content encapsulated in a peer-to-peer transport packet 550, or data block, that may be distributed within peer-to-peer network 200. Peer-to-peer transport packet 550 may include a transport header 560 or other field that may contain parameters that facilitate delivery and processing of data in peer-to-peer network 200. Peer-to-peer transport packet 550 may include a payload field 570 in which one or more content data blocks 571 (such as one or more of data blocks 410 and 420A-420N) may be inserted. Payload field 570 may be of a variable or a pre-defined maximum length. Accordingly, source server 232 may generate a sequence of transport packets 550 that each respectively includes one or more data blocks that each comprise a portion of the content of file 300. In other implementations, segmented content 400 may comprise data blocks of multimedia content produced from a multimedia file or audio/video production equipment. The particular data content of segmented content 400 is immaterial with regard to embodiments described herein and may comprise any data structure format (or portions thereof) that may be distributed in a network system. For example, segmented content 400 may comprise streaming content of a native streaming content format, e.g., ASF, RealAudio, RealVideo, or the like. Thus, transport packet 550 may include streaming content segments inserted into payload field 570.

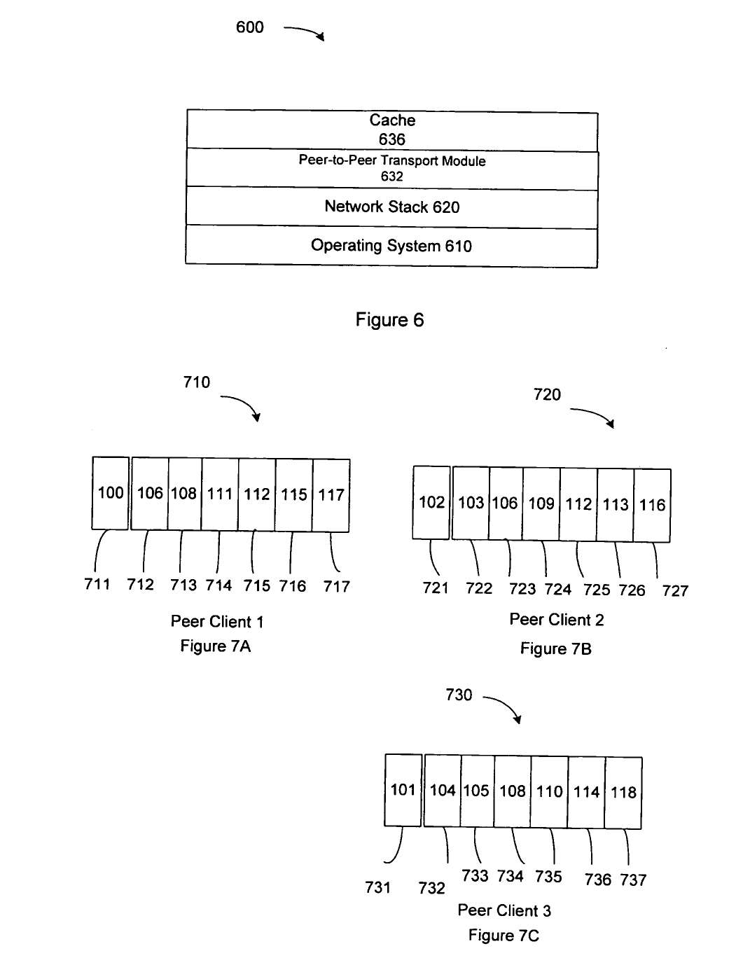

FIG. 6 is a diagrammatic representation of an embodiment of a software configuration 600 that facilitates distribution and storage of multimedia data in a peer-to-peer network. Software configuration 600 comprises sets of computer-executable instructions or code that may be fetched from a memory and executed by a processing unit of a data processing system. Software configuration 600 is preferably run by a peer-to-peer client, such as one or more of clients 210-217 shown in FIG. 2.

Software configuration 600 may include an operating system 610, such as a Windows operating system manufactured by Microsoft Corporation of Redmond, Wash., an OS/2 operating system manufactured by International Business Machines Corporation of Armonk, N.Y., or the like. Operating system 610 may include a network stack 620 for effecting network communications. For example, network stack 620 may be implemented as a transmission control protocol/Internet protocol (TCP/IP) stack.

Software configuration 600 may include a peer-to-peer transport module 632 that comprises logic for self-administration of the peer-to-peer network structure. For example, peer-to-peer transport module 632 may provide self-adjusting functions of the peer client location in the peer-to-peer network topology. Additionally, transport module 632 may provide network transmission and reception functions for data streams. For example, transport module 632 may supply one or more data blocks, such as data blocks 410 and 420A-420N, formatted for delivery in network 200 to network stack 620 for transmission in the peer-to-peer network. Transport module 632 may maintain socket data of peer connections, retrieval functions of data cached by the client for transmission to another client, or other functions that facilitate the client downloading or uploading media data from and to other peer clients or network nodes. Transport module 632, or another suitable software module, may also be adapted to generate and update a sequence number scope list that indicates the sequence numbers of data blocks stored by the client in a file cache 636. Other software layers, such as a browser application, a media player application, or other applications, may be included in software configuration 600.

FIGS. 7A-7C are respective diagrammatic representations of an embodiment of data block storage by clients of a peer-to-peer network. Three respective exemplary client cache storages 710, 720, and 730 are shown to facilitate an understanding of the embodiment. Client cache storage 710 is representative of a client cache of a first peer client (designated Peer Client 1), client cache storage 720 is representative of a client cache of a second peer client (designated Peer Client 2), and client cache storage 730 is representative of a client cache of a third peer client (designated Peer Client 3). In the illustrative example, client cache storage 710 contains multimedia content data blocks 711-717 each having a respective sequence number of 100, 106, 108, 111, 112, 115, and 117. Client cache storage 720 contains multimedia content data blocks 721-727 having respective sequence numbers of 102, 103, 106, 109, 112, 113, and 116. Client cache storage 730 contains multimedia content data blocks 731-737 having respective sequence numbers of 101, 104, 105, 108, 110, 114, and 118. Sequence numbers associated with data blocks maintained in the clients' cache storages provide universal identifiers of multimedia content. Thus, for example, data blocks 712 and 723 store separate instances of common multimedia content as both data blocks 712 and 723 share a sequence number of 106. Peer clients 1-3 may respectively generate or update a sequence number scope list to indicate the sequence numbers of data blocks cached thereby.

Various peer clients may obtain multimedia content from source server 232 or from other peer clients. A client desiring to download multimedia content may first establish a connection with control server 231 for submission of a request that specifies the multimedia content desired for download. Control server 231 may then interrogate a record, such as a database, of clients that have a portion or all of the desired multimedia content and identifies one or more clients that have cached data of the desired multimedia content. Connectivity information of one or more of any clients identified as possibly having the desired multimedia content (or a portion thereof) are returned to the requesting client in the form of peer list 270 of the identified peer clients. Preferably, the peer list includes connectivity information of the identified peer clients. The peer list may include connectivity information of source server 232. Inclusion of connectivity information of source server 232 in peer list 270 may be made in addition to, or in place of, connectivity information of peer clients of peer-to-peer network 200. In accordance with embodiments described herein, a peer client may select one or more nodes, such as peer clients or source server 232, from the received peer list and establish a connection with the selected nodes. The selected nodes, in turn, transmit a sequence number scope list to the peer client. The peer client may then evaluate the received sequence number scope lists and select one or more of the nodes to submit a request for multimedia content therefrom. The client may then generate one or more requests that respectively specify one or more data blocks by identifying the data blocks sequence numbers. The request may specify a particular data block by indicating the requested data block's sequence number. The request may also specify a series of data blocks by indicating a range of data blocks' sequence numbers. The request is then transmitted to one of the selected nodes. The client may then download the desired data blocks from the node(s) with which the client is connected.

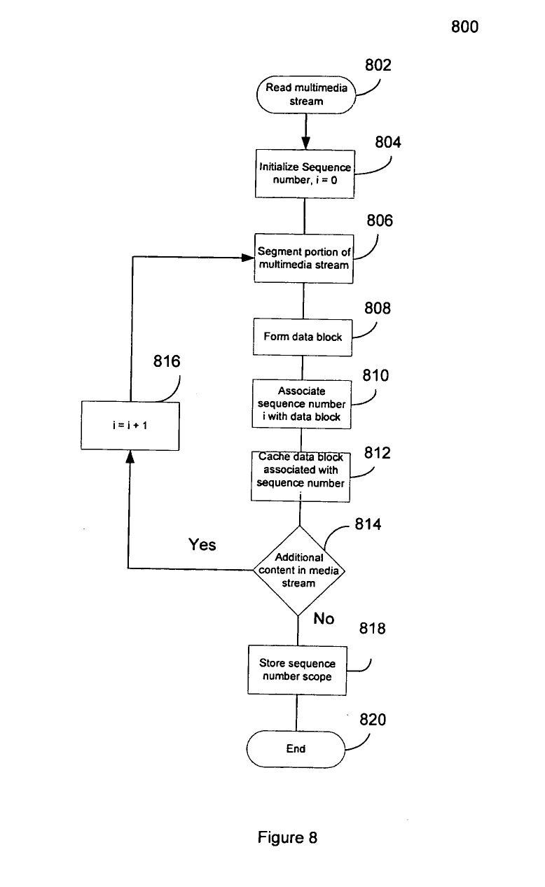

FIG. 8 is a flowchart 800 of an embodiment of a source server processing routine that facilitates distribution of content in a peer-to-peer network. The source server processing routine depicted in FIG. 8 may be implemented as computer-executable instructions, such as one or more routines, subroutines, methods, or other instruction sets, that may be retrieved from a computer-readable medium and executed by a processing unit, such as a general purpose processing unit of source server 232 shown in FIG. 2.

The source server processing routine begins by reading or otherwise receiving a multimedia stream or file (step 802). For example, a streaming file may be retrieved by source server 232 from storage 260. The source server may then initialize a sequence number variable i (step 804). The source server then segments a portion of the multimedia stream (step 806), for example by dividing or otherwise parsing a portion of the content from the multimedia stream. The source server may then form a data block that includes the segmented portion of the multimedia stream (step 808). The sequence number defined by the sequence number variable, i, is then associated with the data block (step 810). The data block is then cached by the source server (step 812). An evaluation may then be made by the source server to determine if additional content remains in the multimedia stream (step 814). In the event that the multimedia stream includes additional content, the source server processing routine may increment the sequence number variable (step 816) and then return to step 806 to segment another portion of the content from the multimedia stream. In the event that it is determined at step 814 that no additional content remains in the multimedia stream, the source server may store a sequence number scope that identifies the sequence numbers of data blocks formed from the multimedia stream that are cached (step 818). The source server processing routine cycle may then end (step 820).

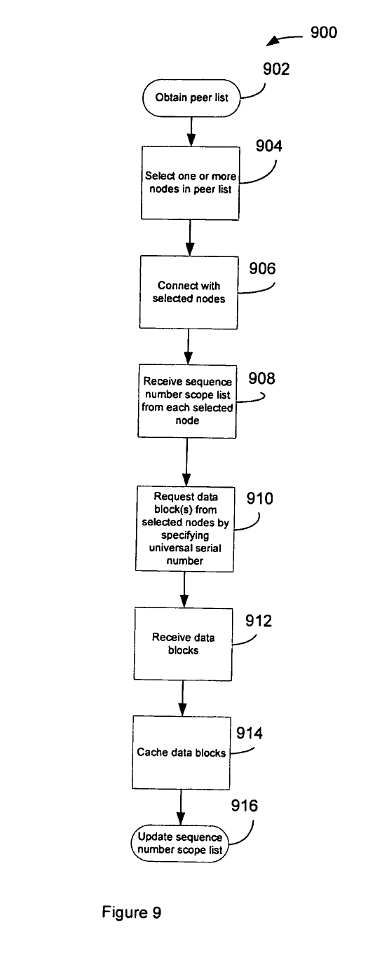

FIG. 9 is a flowchart 900 of an embodiment of a client processing routine that facilitates distribution of content in a peer-to-peer network. The client processing routine depicted in FIG. 9 may be implemented as computer-executable instructions, such as one or more routines, subroutines, methods, or other instruction sets, that may be retrieved from a computer-readable medium and executed by a processing unit, such as a general purpose processing unit of one or more clients 210-217 shown in FIG. 2.

The client processing routine begins by obtaining a peer list that identifies connectivity information of nodes that the client may connect with for obtaining multimedia content (step 902). For example, the peer list may be transmitted to the client upon establishment of a connection between the client and control server 231 shown in FIG. 2. The peer list may include connectivity information of other peer nodes 210-217 in peer-to-peer network 200 and may include connectivity information of servers or other processing nodes, such as source server 232, external to peer-to-peer network 200. On receipt of the peer list, the client may select one or more nodes having connectivity information specified in the peer list (step 904), and the client may then connect with the selected node(s) (step 906). The client then awaits receipt of a respective sequence number scope list of each node with which the client has connected (step 908). The client may then request one or more data blocks from one or more of the nodes with which the client is connected by specifying sequence number(s) of data blocks (step 910). For example, the client may evaluate a sequence number scope list returned from a node and determine if any desired data blocks are cached by the node that originated the sequence number scope list. The client then awaits receipt of the requested data block(s) (step 912). On receipt of the requested data block(s), the client may cache the data blocks (step 914). The client processing routine may then end by the client updating its sequence number scope list to reflect the newly obtained data blocks (step 916).

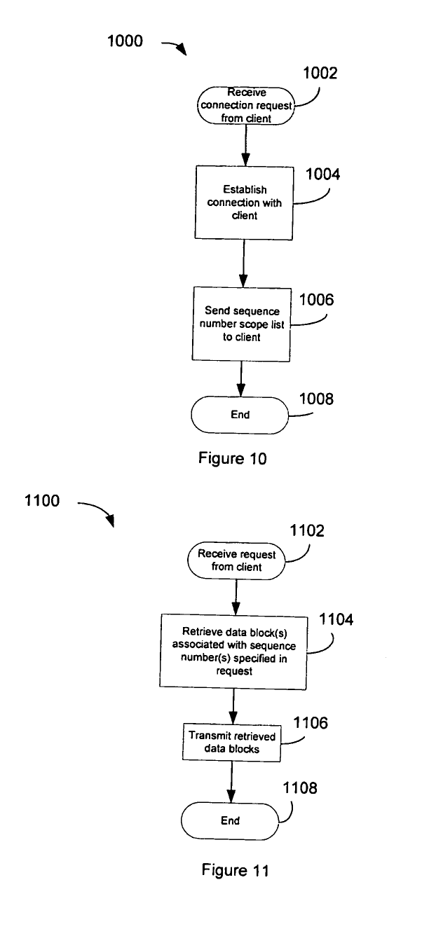

FIG. 10 is a flowchart 1000 of an embodiment of a processing routine that facilitates distribution of a sequence number scope to clients in a peer-to-peer network. The processing routine depicted in FIG. 10 may be implemented as computer-executable instructions, such as one or more routines, subroutines, methods, or other instruction sets, that may be retrieved from a computer-readable medium and executed by a processing unit, such as a general purpose processing unit of one or more clients 210-217 or source server 232 shown in FIG. 2.

The processing routine begins upon receipt of a connection request of a client (step 1002). A connection is then established with the requesting client (step 1004). The processing routine then transmits a sequence number scope list to the client that has established a connection (step 1006), and the processing routine may then end (step 1008). The processing routine depicted in FIG. 10 may be performed by a peer client, such as one or more of clients 210-217, in response to a connection request from another peer client in peer-to-peer network 200. Additionally, the processing routine depicted in FIG. 10 may be performed by a source server, such as source server 232, that is deployed in peer-to-peer network 200 or that is external to peer-to-peer network 200.

FIG. 11 is a flowchart 1100 of an embodiment of a data block distribution processing routine that facilitates distribution of data blocks to clients in a peer-to-peer network. The processing routine depicted in FIG. 11 may be implemented as computer-executable instructions, such as one or more routines, subroutines, methods, or other instruction sets, that may be retrieved from a computer-readable medium and executed by a processing unit, such as a general purpose processing unit of one or more clients 210-217 or source server 232 shown in FIG. 2.

The data block distribution processing routine begins upon receipt of a request for data blocks from a client (step 1102), such as a peer client of network 200 shown in FIG. 2. The request may specify one or more sequence numbers of data block(s) desired by the requesting client. The data block distribution processing routine then retrieves the requested data block(s) from cache (step 1104), and transmits the retrieved data blocks to the requesting client (step 1106). The data block distribution processing routine then ends (step 1108).

As described, embodiments provide a method and computer-readable medium for distribution and storage of multimedia content in a peer-to-peer network. A source server segments a multimedia file or content into data blocks and associates a respective sequence number with each data block. The data blocks are cached by the source server and the source server generates or updates an existing sequence number scope list that identifies the sequence numbers of data blocks stored by the source server. The source server transmits the sequence number scope list in response to establishment of a connection with the peer client. Peer clients may obtain data blocks from the source server by specifying sequence numbers of desired data blocks. On receipt of data blocks, a peer client may cache the received data blocks and update or generate a sequence number scope list that identifies the sequence number of respective data blocks stored by the peer client. The peer client may then upload data blocks to other peer clients that request the data blocks by specifying the sequence numbers of desired data blocks. In this manner, the sequence numbers of data blocks provide a universal identification of multimedia content in a peer-to-peer network.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of identifying multimedia content in a peer-to-peer network, comprising:
segmenting a multimedia data structure into a plurality of data blocks;
respectively associating each of a plurality of sequence numbers with one of the plurality of data blocks;
storing the plurality of data blocks;
recording the plurality of sequence numbers; and
distributing at least a portion of the plurality of data blocks in the peer-to-peer network, wherein distributing the portion of the plurality of data blocks maintains the association of respective sequence numbers.

2. The method of claim 1, wherein recording the plurality of sequence numbers comprises recording the plurality of sequence numbers in a sequence number scope list.

3. The method of claim 2, further comprising:
establishing a connection with a client of the peer-to-peer network; and
transmitting the sequence number scope list to the client.

4. The method of claim 3, further comprising:
receiving a request from the client that specifies one or more of the plurality of sequence numbers; and
transmitting, to the client, one or more of the plurality of data blocks respectively associated with the one or more of the plurality of sequence numbers specified in the request.

5. A method of distributing multimedia content in a peer-to-peer network, comprising:
establishing a connection with a data processing system;
receiving a sequence number scope list from the data processing system that includes a plurality of sequence numbers each respectively associated with one of a plurality of data blocks;
generating a request that specifies one or more of the sequence numbers;
transmitting the request to the data processing system;
receiving one or more data blocks each respectively associated with one of the one or more sequence numbers specified in the request; and
storing the one or more data blocks in association with the associated one or more sequence numbers.

6. The method of claim 5, wherein establishing a connection with a data processing system comprises establishing a connection with a peer client in the peer-to-peer network.

7. The method of claim 5, wherein establishing a connection with a data processing system comprises establishing a connection with a multimedia server external to the peer-to-peer network.

8. The method of claim 5, further comprising updating a record to include the one or more sequence numbers.

9. The method of claim 5, further comprising:
receiving, from a peer client in the peer-to-peer network, a request that specifies one of the one or more sequence numbers; and
transmitting a data block associated with the sequence number.

10. A computer-readable medium for identifying multimedia content in a peer-to-peer network, comprising:
instructions that segment a multimedia data structure into a plurality of data blocks;
instructions that respectively associate each of a plurality of sequence numbers with one of the plurality of data blocks;
instructions that store the plurality of data blocks;
instructions that record the plurality of sequence numbers; and
instructions that distribute at least a portion of the plurality of data blocks in the peer-to-peer network, wherein distribution of the portion of the plurality of data blocks maintains the association of respective sequence numbers.

11. The computer-readable medium of claim 10, wherein the instructions that record the plurality of sequence numbers record the plurality of sequence numbers in a sequence number scope list.

12. The computer-readable medium of claim 11, further comprising:
instructions that establish a connection with a client of the peer-to-peer network; and
instructions that transmit the sequence number scope list to the client.

13. The computer-readable medium of claim 12, further comprising:
instructions that receive a request from the client that specifies one or more of the plurality of sequence numbers; and
instructions that transmit, to the client, one or more of the plurality of data blocks respectively associated with the one or more of the plurality of sequence numbers specified in the request

14. A computer-readable medium for distributing multimedia content in a peer-to-peer network, comprising:
instructions that establish a connection with a data processing system;
instructions that receive a sequence number scope list from the data processing system that includes a plurality of sequence numbers each respectively associated with one of a plurality of data blocks;
instructions that generate a request that specifies one or more of the plurality of sequence numbers;
instructions that transmit the request to the data processing system;
instructions that receive one or more data blocks each respectively associated with one of the one or more sequence numbers specified in the request; and
instructions that store the one or more data blocks in association with the associated one or more sequence numbers.

15. The computer-readable medium of claim 14, wherein the instructions that establish a connection with a data processing system comprise instructions that establish a connection with a peer client in the peer-to-peer network.

16. The computer-readable medium of claim 14, wherein the instructions that establish a connection with a data processing system comprise instructions that establish a connection with a multimedia server external to the peer-to-peer network.

17. The computer-readable medium of claim 14, further comprising instructions that update a record to include the one or more sequence numbers.

18. The computer-readable medium of claim 14, further comprising:
instructions that receive, from a peer client in the peer-to-peer network, a request that specifies a sequence number; and
instructions that transmit a data block associated with the sequence number to the peer client.

19. A system for distribution of multimedia content in a peer-to-peer network, comprising:
means for associating each of a plurality of sequence numbers with one of a plurality of data blocks;
means for storing the plurality of data blocks;
means for distributing at least a portion of the plurality of data blocks to a peer client in the peer-to-peer network; and
means for storing the portion of the plurality of data blocks in association with respective sequence numbers of the plurality of sequence numbers.

20. The system of claim 19, wherein the means for associating comprises means for recording the plurality of sequence number in a sequence number scope list.
